(19) United States
(12) Patent Application Publication
(10) Pub. No.: US 2008/0257656 A1
(43) Pub. Date: Oct. 23, 2008

(54) BRAKE MONITORING SYSTEM

(76) Inventors: Robert Skinner, Lebanon, OR (US); Terry L. Elstad, Portland, OR (US)

Correspondence Address: IAN F. BURNS & ASSOCIATES, 4790 Caughlin Parkway #701, RENO, NV, 89519-0907, US

(21) Appl. No.: 11/875,111

(22) Filed: Oct. 19, 2007

Related U.S. Application Data
(63) Continuation-in-part of application No. 10/979,435, filed on Nov. 1, 2004.

(51) Int. Cl. F16D 66/00

(52) U.S. Cl. 188/1.11 E

(57) ABSTRACT

A brake monitoring system is disclosed. The monitoring system includes a primary braking system located in a towing vehicle. A towed vehicle is releasably attached to the towing vehicle. A towed vehicle braking system is mounted in the towed vehicle. An auxiliary braking device is configured to activate the towed vehicle braking system and to sense at least one parameter of the auxiliary braking device or of the towed vehicle braking system. A transmitter is in communication with the auxiliary braking device. The transmitter is configured to send a signal about the parameter. A receiver is located in the towing vehicle. The receiver is configured to receive the signal from the transmitter. A display is located in the towing vehicle and is in communication with the receiver. The display is configured to display a message to a towing vehicle occupant about the parameter.

### CROSS REFERENCE TO RELATED APPLICATIONS

This application is a Continuation in Part of U.S. patent application having Ser. No. 10/979,435, filed on Nov. 1, 2004.

### FIELD OF THE INVENTION

The present invention relates to monitoring systems and devices for auxiliary braking devices. In particular, the present invention relates to monitoring devices and systems for auxiliary brake systems including auxiliary braking devices that may be used for stopping or slowing down vehicles being towed.

### BACKGROUND

In some situations, when a vehicle is being towed, the towed vehicle relies on the braking system of the towing vehicle for stopping or slowing down. This situation typically produces undue stress on the towing vehicle's braking system. As a result, the life span of the towing vehicle's braking system could be significantly shortened. For instance, the brake pads of the towing vehicle could wear out faster. This situation may pose a risk that the towing vehicle will lose its brakes, perhaps causing an accident.

Furthermore, significant stress on the vehicle connection system, such as the hitch, may result when the towing vehicle stops or slows down the towed vehicle. If stress exceeds the structural strength of the hitch, catastrophic failure of the hitch may result. In such an event, the towed vehicle may become decoupled from the towing vehicle.

Auxiliary braking systems have been developed to try to solve these problems. Some jurisdictions require the use of auxiliary braking systems, especially when the vehicle being towed is heavy. One auxiliary brake system is generally described in U.S. Pat. No. 5,954,164 issued to Latham. Latham essentially utilizes a weighted pendulum attached to the towed vehicle. When the towing vehicle and the towed vehicle decelerate, the inertia of the weighted pendulum will generally cause the pendulum to swing toward the brake pedal of the towed vehicle so as to apply the brakes of the towed vehicle.

At least one potential problem with the brake system in Latham is that different vehicles may require different brake pedal force or pressure to efficiently actuate their brakes and thus require different pendulum weights. A user of the braking system of Latham might find that the pendulum weight included with the purchase is incompatible with the type of vehicle the user has.

An auxiliary braking system that allows the user to adjust the range of force that may be applied to the towed vehicle's brake pedal is desired. For instance, a single auxiliary braking system that would stop or decelerate vehicles of different weights, such as both a light compact car and a large heavy van, is desirable.

Another possible problem with the brake system in Latham is that the weighted pendulum does not allow much room for control. Once the pendulum is set in motion, there appears no way of slowing it down or controlling the force or pressure exerted by the pendulum on the brake pedal. Therefore, an auxiliary braking system is desired that could be more controllable than the pendulum-based braking system of Latham.

A brake controller for use in a towed vehicle to control the application of the towed vehicle's brakes is disclosed purportedly in U.S. Pat. No. 6,050,649 issued to Hensley. The brake controller essentially consists of an optical coupler that senses the movement of the brake pedal of the towing vehicle by a graduated increase in transmitted light, or by counting marks associated with a spring-tensioned cable or chain secured between the tow vehicle firewall and the brake pedal arm. The optical coupler appears to produce a brake control signal, which is representative of the desired braking of the towed vehicle. The optical coupler generally sends the brake control signal in the form of a current flow to a micro-controller to generate an output signal for actuating the electric brakes of the towed vehicle.

At least one possible problem with the brake controller in Hensley is that it completely relies on an electric-based drive mechanism. Electric-based drive mechanisms, such as the brake controller of Hensley, have a high power requirement, which may drain the battery of the towed vehicle, if used as a power source over a period of time.

Another potential disadvantage is that the Hensley system is dependent on an input from the towing vehicle's brake pedal to actuate the towed vehicle's brakes. In the event communication between the system sensor and the micro-controller is lost, the braking system could be unable to actuate the towed vehicle's brakes. This could result in excessive wear on the brakes of the towing vehicle; in the failure of the linkage between the towed and towing vehicle; and/or in safety concerns due to inadequate braking power. It would be beneficial to provide a device in the towed vehicle that initiates braking of the towed vehicle. In addition, it would be beneficial to provide a device that automatically activates the brakes in the towed vehicle upon failure of the linkage between the towed and towing vehicle.

Another possible issue with the electrically powered auxiliary brake system like the Hensley invention is that a loss of electrical power during the brake activation by the electric powered system could improperly leave the brake system activated. This unwanted braking of the towed vehicle during the towing could result in possible damage and resulting brake failure for the towed vehicle.

Yet another potential problem for the electrically powered auxiliary brake system like the Hensley system could be the possible accidental and unwanted activating of the brake system through a fault in the brake light system of the towing vehicle. Some vehicles have a brake light system that combines brake light with parking or riding light in one bulb, like the 1157 brake/riding light bulb. This type of bulb has two filaments, one that is energized for the brake light and one that is energized for the parking or running light. If the running light filament is broken while the running lights are on, it is possible for the energized portion of the broken running light filament to make contact with and energize the brake light filament. In this manner, the brake light circuit could become energized. If the Hensley system is electrically connected to the brake light system of a towing vehicle that has a combined brake/running light system, the accidental energizing of the brake light system could result in unwanted activation of the auxiliary braking system/towed vehicle's braking system, resulting in possible damage to or failure of the towed vehicle's braking system.

A brake actuation system for towed vehicles is also disclosed in U.S. patent publication number 2002/0030405 filed by Harner, et al. Harner et al. discloses a brake controller that transmits a variable voltage, which in turn causes an electromagnet to produce a strong magnetic field. The magnetic field causes a steel sheave to rotate, which then urges arms or knuckles to rotate. This causes an actuating cable that is secured to the tow vehicle brake pedal to move.

In addition to the problems identified above for electric-based drive mechanisms, the brake actuation system in Harner et al. is intrusive. For instance, the user has to open the hood of the towed vehicle to install the Harner et al. brake controller and to connect the system with the master brake cylinder of the towed vehicle. As one of ordinary skill may appreciate, the brake actuation system of Harner et al. requires substantial labor and time to install. The brake actuation system also uses a vacuum source that is directly connected to the master brake cylinder of the towed vehicle. Using a vacuum source may be problematic. First, the connection itself must be airtight; any leaks in the connection will cause the braking system of the towed vehicle to fail. Second, the use of vacuum mandates extensive maintenance. Third, a loss of vacuum in the master brake cylinder may cause the braking system of the vehicle with the Harner et al. brake actuation system installed therein to fail. Finally, Harner et al.'s system may not be compatible with, or may interfere with, the operation of at least some anti-lock braking systems (ABS).

Another vacuum-actuated towed-vehicle brake actuation system is described in U.S. Pat. No. 6,158,823 issued to Shuck. Shuck discloses an electrically controlled, vacuum-operated brake actuation system that uses a towing vehicle's brake light to control the activation and deactivation of the brake actuation system for the towed vehicle. At least one disadvantage of this system is that the braking force applied to the brake pedal of the towed vehicle cannot be controlled. Because the system described in Shuck is also vacuum operated, Shuck's system also suffers from the disadvantages of Harner et al.'s system described above.

Additionally, as described for the Hensley system, if the Shuck system is electrically connected to the brake light system of a towing vehicle that utilizes a dual filament bulb for a combined brake/running light system, an electrical short or fault in the dual filament bulb could accidentally cause the unwanted activation of the Shuck auxiliary braking system/towed vehicle's braking system leading to possible damage to or failure of the towed vehicle's braking system.

Another brake control system is disclosed in U.S. Pat. No. 6,280,004 issued to Greaves, Jr. The braking system in Greaves, Jr. has two switches to control the actuation of the towed vehicle's brakes. One switch is a brake switch that is closed when the user depresses a brake pedal to actuate the brake of a towing vehicle and the other switch is a microswitch positioned in proximity to the tow hitch such that the microswitch is closed when the towed vehicle exerts a forward pressure against the towing vehicle.

Similar to the system disclosed in Shuck, the brake control system disclosed in Greaves, Jr. is controlled by connecting the brake control system to the brake light of the towing vehicle. Thus, Greaves, Jr. suffers from the disadvantages of Shuck's system described above, such as incompatibility with ABS systems and lack of control on the force being exerted on the towed vehicle's brake pedals. Greaves, Jr.'s system is also intrusive because it taps into the brake lines. Furthermore, the microswitch activation requires a considerable amount of play in the tow hitch assembly. Because of the amount of required play, the Greaves, Jr.'s microswitch activation may not work with some hitch assemblies having low tolerances or minimal play.

Additionally, as described for the Hensley and Shuck supplementary braking systems, if the Greaves, Jr. supplementary brake system is electrically connected to the brake light of a towing vehicle that utilizes a dual filament bulb for a combined brake/running light system, an electrical short or fault in the dual filament bulb could accidentally cause the unwanted activation of the Greaves, Jr. auxiliary braking system/towed vehicle's braking system leading to possible damage to or failure of the towed vehicle's braking system.

What has long been needed is an auxiliary braking system that does not suffer from at least some of the disadvantages stated above.

### SUMMARY OF THE INVENTION

### Advantages of One or More Embodiments of the Present Invention

The various embodiments of the present invention may, but do not necessarily, achieve one or more of the following advantages:

the ability to use a magnetic field to control a brake pedal of a vehicle being towed;

provide pressure to the brake pedal of a vehicle being towed with a pressure substantially proportional to a detected amount of deceleration;

provide an auxiliary braking device that is reactive to a change in momentum of the vehicle being towed;

the ability to variably control the pressure being applied to the brake pedal of the vehicle being towed;

provide an auxiliary braking device with little tendency to overheat the brakes of the vehicle being towed;

provide an auxiliary braking device that requires minimal power to operate;

provide an auxiliary braking system that upon a loss of power automatically disengages the system;

provide an auxiliary braking device that does not require tapping into brake lines of the vehicle being towed;

provide a portable auxiliary braking device that may be used for a variety of vehicle types;

provide an auxiliary braking device that may be easily assembled or set-up;

provide an auxiliary braking device that is not likely to void the towed vehicle's warranty;

provide an auxiliary braking device that is compatible with vehicles having ABS braking systems;

the ability to allow braking pressure to be adjusted according to a braking requirement of a vehicle being towed;

provide varying levels of braking power;

provide an indicator to the driver of a towing vehicle that the battery of the towed vehicle is running low;

provide feedback to the driver of the towing vehicle that the braking device for a towed vehicle is functioning correctly;

provide a monitoring system for monitoring the operation of a braking device for a towed vehicle;

provide a device to alert a driver of a towing vehicle when the braking system of a towed vehicle is not operating properly;

provide an indicator to the driver of a towing vehicle of tire pressure in a towed vehicle; and

provide a display to the driver of a towing vehicle that can indicate various operating parameters of a braking system and of a towed vehicle.

These and other advantages may be realized by reference to the remaining portions of the specification, claims, and abstract.

### Brief Description of Embodiments of the Present Invention

In one embodiment of the present invention, a brake monitoring system is provided that includes a primary braking system. The primary braking system is located in a towing vehicle. A towed vehicle is releasably attached to the towing vehicle. A towed vehicle braking system is mounted in the towed vehicle. An auxiliary braking device is configured to activate the towed vehicle braking system and to sense at least one parameter of the auxiliary braking device or of the towed vehicle braking system. A transmitter is in communication with the auxiliary braking device. The transmitter is configured to send a signal or message about the parameter. A receiver is located in the towing vehicle. The receiver is configured to receive the signal or message from the transmitter. A display is located in the towing vehicle and is in communication with the receiver. The display is configured to display the message to a towing vehicle occupant.

In another embodiment of the present invention a method for monitoring a braking system is provided. The method includes braking a towing vehicle and activating a braking system in a towed vehicle. A parameter of the braking system in the towed vehicle or a parameter of the towed vehicle is sensed. A message about the parameter is transmitted from a transmitter located in the towed vehicle. The message is received by a receiver located in the towing vehicle. The message is displayed to an occupant of the towing vehicle.

The above description sets forth, rather broadly, a summary of embodiments of the present invention so that the detailed description that follows may be better understood and contributions of the present invention to the art may be better appreciated. Some of the embodiments of the present invention may not include all of the features or characteristics listed in the above summary. There may be, of course, other features of the invention that will be described below and may form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a side view of a towing vehicle and a towed vehicle having an embodiment of the auxiliary braking device of the present invention installed therein.

FIG. 2 is substantially a schematic diagram of the components of an embodiment of the auxiliary braking device of the present invention.

FIG. 3A is substantially an exploded view of an embodiment of a valve member of the present invention.

FIG. 3B is substantially an exploded view of an embodiment of a valve actuator member of the present invention.

FIG. 4 is substantially a side perspective view of an embodiment of the auxiliary braking device of the present invention.

FIG. 5 is substantially a flow chart of one method of operation of an embodiment of the auxiliary braking device of the present invention.

FIG. 6 is substantially a block diagram of components of an embodiment of an auxiliary brake system of the present invention.

FIG. 7 is substantially a circuit diagram for a receiver that may be used with certain embodiments of the present invention.

FIG. 8 is substantially a circuit diagram for a transmitter that may be used with certain embodiments of the present invention.

FIG. 9 is substantially a circuit diagram of an embodiment of a controller that may be used with the present invention.

FIG. 10 is substantially a block diagram of components of an alternative embodiment of an auxiliary brake system of the present invention.

FIG. 11 is substantially a front view of a display of the present invention that may be mounted in a towing vehicle.

FIG. 12 is substantially a chart of operating messages that can be displayed by the display of the present invention.

FIG. 13 is substantially another chart of operating messages that can be displayed by the display of the present invention.

FIG. 14 is substantially a circuit diagram of an embodiment of a controller that may be used with the present invention.

### DESCRIPTION OF EMBODIMENTS OF THE PRESENT INVENTION

In the following detailed description of the embodiments, reference is made to the accompanying drawings, which form a part of this application. The drawings show, by way of illustration, exemplary embodiments in which the invention may be practiced. It is to be understood that other embodiments may be utilized and/or structural changes may be made without departing from the scope of the present invention.

As used herein, the term “vehicle” refers to any equipment used to carry or transport objects, including without limitation, mechanized equipment, non-mechanized equipment, automobiles, trailers, recreational vehicles, commercial vehicles, and the like. The term “fluid” is used to refer to a substance tending to flow, including without limitation, a liquid, such as oil, or a gas, such as air. The term “chamber” is used to refer to an enclosed space or cavity and may be interchanged with the term “cylinder.” While the term “cylinder” may refer to a chamber having a cylindrical shape, the cylindrical shape should not be used to limit the term, and a variety of chamber shapes should fall within the scope of the present invention. The applicant utilizes various spatially orienting terms, such as “upper,” “lower,” “horizontal,” and “vertical.” It is to be understood that these terms are used for ease of description of the embodiments with respect to the drawings but are not necessarily in themselves limiting or requiring of an orientation as thereby described.

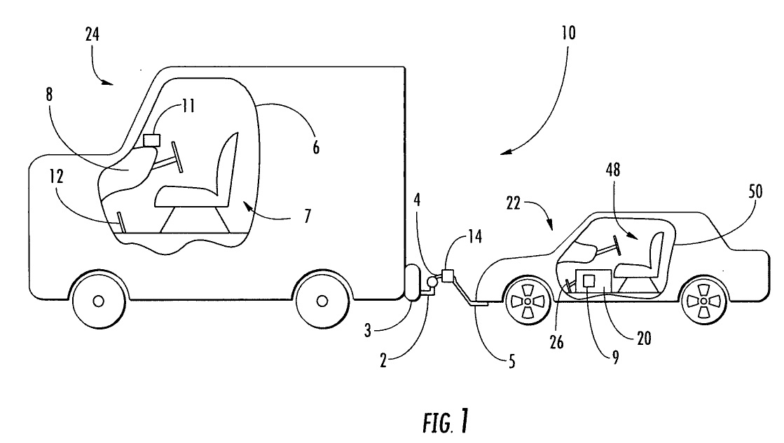

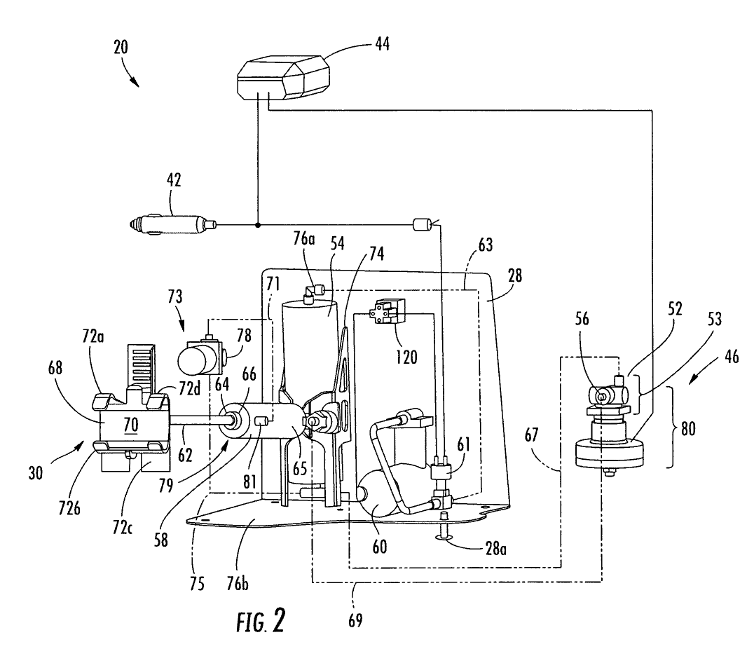

FIG. 1 is substantially a side view of a towing vehicle 24 and a towed vehicle 22 having an embodiment of the auxiliary brake system 10 of the present invention installed therein and used for stopping or slowing down the towed vehicle 22. Auxiliary brake system 10 may further comprise an auxiliary braking device 20 (hereinafter referred to as “ABD”) residing in the towed vehicle 22. Auxiliary brake system 10 may further comprise a receiver unit 11 residing in the towing vehicle 24 and a transmitter unit 9 located in towed vehicle 22. Receiver unit 11 may be integrated into ABD 20 or may be a separate unit, operatively connected with ABD 20. ABD 20 supplements the brake system of a towing vehicle 24 in stopping or slowing down a vehicle being towed 22. In certain embodiments, ABD 20 provides auxiliary braking to towed vehicle 22 by contacting the towed vehicle's brake pedal 26 and depressing brake pedal 26 when appropriate.

Towing vehicle 24 is illustrated as having a towing “ball” 2 coupled to the bumper 3 of towing vehicle 24. A “hitch attachment” 4 is coupled to a suitable structure 5 of the towed vehicle 22. Accordingly, when hitch attachment 4 is coupled to towing ball 2, the towing vehicle 24 tows the towed vehicle 22. Of course, the above-described means of coupling the towing vehicle 24 and the towed vehicle 22 may be effected with any suitable means, and alternative embodiments of the auxiliary brake system 10 may be employed with any such means.

The cut-away line 6 demarks the outside and an inside portion 7 of the towing vehicle 24. For convenience, receiver unit 11 is illustrated as sitting on top of a dashboard 8. In one embodiment, receiver unit 11 is affixed to dashboard 8 using a suitable means, such as Velcro, a strap, a bracket, or the like. As will be discussed further, receiver unit 11 may, among other things, provide an indication to occupants of the towing vehicle that the auxiliary brake system 10 is functioning as intended and/or is not functioning as intended.

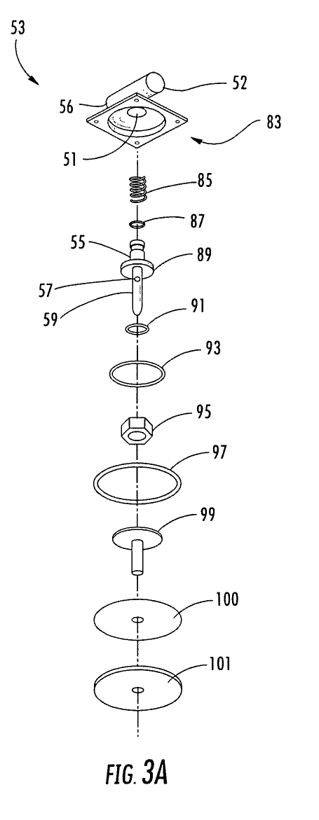

The cut-away line 50 demarks the outside and an inside portion 48 of the towed vehicle 22. For convenience, an ABD 20 is illustrated as sitting on the floor of towed vehicle 22 in front of a driver seat. ABD 20 may comprise adjustable feet 28a (FIG. 2) on its bottom surface to help position the device. Adjustable feet may be made in various ways that provide for the adjustment of the feet. For example, adjustable feet 28a may comprise threaded rods that allow the feet to be threaded into sockets. By rotating the feet into and out of the sockets, the height of the feet may be adjusted. Feet 28a may also be adjusted horizontally to allow ABD to be more easily place on irregularly shaped floors. In one embodiment, ABD 20 is affixed to the floor using means such as Velcro, a strap, a bracket or the like. ABD 20 is coupled to the brake pedal 26 as described herein.

At least one embodiment includes a break away system 14. Break away system 14 is configured to detect separation of towed vehicle 22 from towing vehicle 24, such as during a failure of towing ball 2 and/or hitch attachment 4. This condition may be communicated to the driver of towing vehicle 24, such as by providing a visible indicator on receiver unit 11.

Referring now to FIG. 2, there is shown a schematic diagram illustrating the components of an embodiment of ABD 20. In one embodiment, ABD 20 is powered by a battery (not shown) of towed vehicle 22. ABD 20 may be connected to the battery through a cigarette lighter adapter 42. In other embodiments, other power sources are employed. For example, an auxiliary battery (not shown) may provide power to ABD 20.

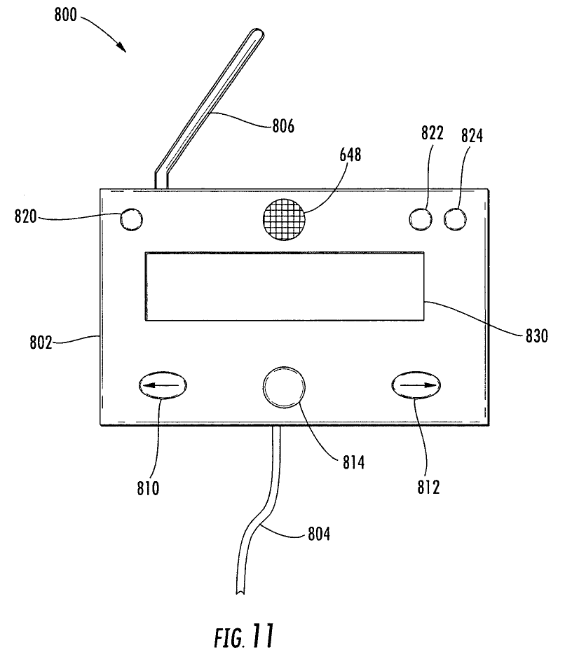

ABD 20 may include a controller 44. Controller 44 may preferably be an inertia-sensing device that detects a change in the momentum or velocity of the vehicle being towed and converts the detected deceleration into an electrical signal or an output voltage level. The electrical signal level may be proportional to the deceleration detected by the controller 44. A circuit diagram for one embodiment of a controller 44 is illustrated in FIG. 9, discussed further below.

In at least one embodiment, ABD 20 includes a fluid source. The fluid source may provide air as fluid to ABD 20. As would be apparent to one of skill in the art, other types of fluids may be used, such as various types of gases or liquids.

The fluid source may utilize an air compressor 60 if the fluid is a gas such as air for possibly pressurizing the fluid to possibly provide mechanical power for the invention. In at least another embodiment of the invention where the fluid is a liquid, a pump (not shown) may be substituted for the air compressor 60 to possibly provide the pressurizing of the fluid needed to possibly provide mechanical power for the invention. The air compressor 60 or pump, (not shown) may also be powered by the battery (not shown) of towed vehicle 22 through a cigarette light adapter 42. A relay switch 120 may be provided to efficiently distribute the power from the battery of the towed vehicle. A fluid reservoir 54 may be in fluid communication with air compressor 60 through a first fluid connector 63. Fluid reservoir 54 may be configured to store the fluid received from air compressor 60.

A support frame 74 may be attached to fluid reservoir 54 and ABD housing wall 76a to maintain an upright position of fluid reservoir 54. The bottom portion of air compressor 60 may be fastened directly to ABD housing wall 76b to provide a stable air compressor mounting. Fluid reservoir 54 may be coupled to a first regulator 46 through an inlet port 52 by a second fluid connector 67. Fluid connectors may include tubes, fittings, and fasteners known in the art.

The fluid pressure in fluid reservoir 54 may be regulated by an optional pressure switch 61. Pressure switch 61 turns air compressor 60 on and off depending on fluid pressure requirements of the fluid source. The fluid pressure requirement of the fluid source may be a pre-determined optimal pressure necessary for efficient functioning of ABD 20. The fluid pressure in the fluid source may be user-controllable.

Controller 44 may be in electronic communication with first regulator 46 and may be configured to send an electric signal of a particular voltage to first regulator 46. The voltage of the output signal may be proportional to the inertia change sensed by controller 44 as discussed above. The proportional output signal allows braking to be applied in proportion to the amount of deceleration. First regulator 46 may include a valve member 53 and a valve actuator member 80.

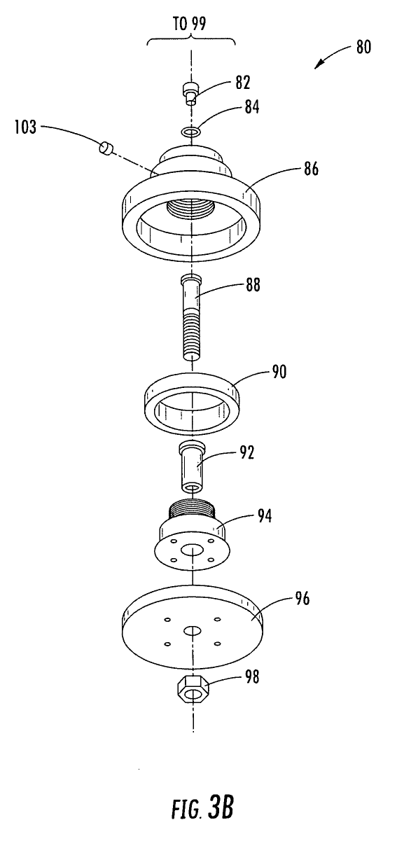

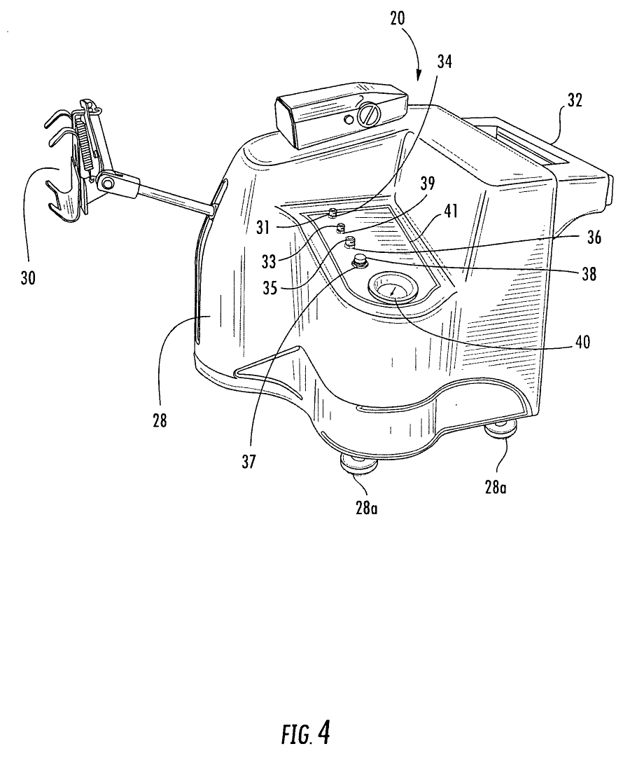

With reference now to FIG. 3A, there is shown an exploded view of valve member 53 of first regulator 46. Valve member 53 may include an inlet port 52 and an outlet port 56 positioned exterior of a valve member housing 83. Within the interior of valve member housing 83, there exists a fluid passage 51 that connects inlet port 52 and outlet port 56. Valve member 53 further includes a plunger 89 configured to be positioned within valve member housing 83 and substantially around fluid passage 51 or in between inlet port 52 and outlet port 56.

Plunger 89 may be configured to move from a closed position, wherein plunger 89 blocks fluid passage 51, to an open position, wherein plunger 89 allows fluid communication between inlet port 52 and outlet port 56, and vice-versa. A plunger retainer spring 85 and a plunger o-ring 87 may be positioned around a first end 55 of plunger 89. Spring 85 may also be any biasing device known in the art, or later developed, and may be configured to bias plunger 89 to be in the closed position and to allow plunger 89 to move between open and closed positions. Plunger 89 may define a vent 57 to prohibit or substantially reduce the risk of vacuum formation within the plunger and housing, thereby allowing plunger 89 to move smoothly.

Around second end 59 of plunger 89, a plunger seal 91, a retaining bolt seal 93, and a retaining bolt 95 may be attached to plunger 89 to ensure that fluid can only exit out of valve member 53 through outlet port 56. Retaining bolt 95 may be threaded and may be configured to mount plunger 89 and the seals 91 and 93 to valve member housing 83, which may have a threaded end to receive and retain retaining bolt 95. A septum seal 97, a rivet 99, a septum 100, and a septum retainer 101 may be attached to plunger 89 to further ensure that fluid can only exit out of valve member 53 through outlet port 56. Modifications to the components of valve member 53 may be made that still fall within the scope of the invention. Modifications may include eliminating a component or replacing a component. Valve member 53 may be obtained from Wilkerson Company of Englewood, Colo.

With reference to FIG. 2 again, valve member 53 may be configured to be attached to valve actuator member 80. Valve member 53 may be coupled to valve actuator member 80 via a threaded bottom portion of valve member 53 and a threaded neck of valve actuator member 80. Other fastener types known in the art may be used to couple valve member 53 and valve actuator member 80. With reference now to FIG. 3B, valve actuator member 80 may be an electromagnet assembly, which causes plunger 89 (FIG. 3A) of valve member 53 (FIG. 3A) to move from the open position to the closed position and vice-versa. Other motors or actuators known in the art, or later developed, may be used as a substitute for the electromagnet assembly.

Valve actuator member 80 may include a valve shaft 88, which is configured to be coupled to rivet 99 (FIG. 3A) and to be indirectly coupled to plunger 89 (FIG. 3A) of valve member 53 (FIG. 3A) via a first bushing 82 and an o-ring 84. Valve shaft 88 may couple an electromagnetic coil 90 and magnetic disc 96, which may be positioned inside an electromagnetic housing 86. A second bushing 92 and a coil adaptor 94 may be inserted in-between coil 90 and valve shaft 88 to snugly position coil 90 onto electromagnetic housing 86 and valve shaft 88. The magnetic disc 96 may be positioned on valve shaft 88 proximate to coil adaptor 94 and coil 90. A nut 98 may be used to secure electromagnetic coil 90, second bushing 92, coil adaptor 94, and magnetic disc 96 to valve shaft 88. Valve shaft 88 may have an end opposite to the plunger that is threaded to receive a nut 98. Valve actuator member 80 may further include a set screw 103 that may be used to hold the coil adapter 94 in place and allow a user to adjust the distance between coil 90 and magnetic disc 96. Set screw 103 may further allow a user to set the range of force for driving the plunger and consequently the range of fluid pressure that valve actuator member 80 may be able to generate and transmit.

A wire (not shown) from controller 44 (FIG. 2) may be connected to coil 90 allowing electronic communication between coil 90 and controller 44. An electric signal from controller 44 may provide power to coil 90 and activate valve actuator member 80. The activation of valve actuator member 80 causes magnetic disc 96 to move toward housing 86. Because magnetic disc 96 is coupled to shaft 88 and plunger 89 (FIG. 3A), the activation of coil 90 causes the plunger 89 to move to the open position thereby allowing fluid flow from inlet port 52 (FIG. 3A) to outlet port 56 (FIG. 3A). The degree and time of the opening of the plunger 89 may be controlled by the strength and duration of the electrical signal received by valve actuator member 80, which is dependent on the level and duration of inertial change sensed by the controller 44, as discussed above.

In at least one embodiment, the valve actuator member 80 may be configured so that when plunger 89 blocks the passage between inlet port 52 and outlet port 56, it allows for a connection between outlet port 56 and a relief port (not shown). In this manner, when fluid is not being introduced from outlet port 56 into the fluid chamber 58 via first regulator 46, fluid in the fluid chamber 58, if the fluid is air, could be vented to the outside atmosphere.

Referring back to FIG. 2, outlet port 56 of first regulator 46 may be coupled to a head 65 of a fluid chamber 58 via a third fluid connector 69, which may be made from tubes, fittings, and fasteners known in the art. Outlet port 56 may be configured to send fluid to fluid chamber 58. Internal pressure within fluid chamber 58 may be built by the flow and the supply of fluid from outlet port 56 of first regulator 46. In one embodiment, an initial internal pressure may be maintained at approximately 9 pounds per square inch (psi) within fluid chamber 58. Other embodiments may employ other suitable working pressures of the fluids in fluid chamber 58. An increase in internal pressure within fluid chamber 58 caused by a detected deceleration of towed vehicle 22 subsequently actuates brake actuator 30. Brake actuator 30 may include a brake actuator shaft 62 that is moveably coupled to fluid chamber 58. Brake actuator shaft 62 may be configured to slide parallel to a horizontal axis, and a portion of brake actuator shaft 62 may be configured to move in and out of fluid chamber 58.

Fluid chamber 58 may include a shaft passage 64 that is configured to receive brake actuator shaft 62 with a sealably sliding fit, which minimizes the seepage of fluid out of fluid chamber 58. A shaft bushing 66 may be used to provide the sealably sliding fit between brake actuator shaft 62 and fluid chamber 58. Brake actuator shaft 62 may be biased by biasing devices known in the art, or those later developed, such as a spring or fluid pressure directed opposite to the actuating position of shaft 62. Biasing devices bias shaft 62 to a position where it has the tendency to move toward fluid chamber head 65 and away from the brake pedal 26 (shown in FIG. 1) of the towed vehicle 22 (shown in FIG. 1).

Brake actuator 30 may further include a pedal clamp structure 68 configured to be attachable to brake pedal 26 (FIG. 1) of towed vehicle 22 (FIG. 1). Pedal clamp structure 68 may include a plate 70 attached at an end of brake actuator shaft 62 that is away from fluid chamber head 65. Pedal clamp structure 68 may further include a plurality of fingers 72a-d protruding from plate 70 and bent toward the surface of plate 70 to form a clamp-like structure. Fingers 72 may be made of materials that are the same or similar to the materials used for plate 70 and that are attached substantially perpendicular to plate 70 and that have extensions substantially parallel or at an angle relative to plate 70 to form a clamp-like structure. Plate 70 may be made of multiple pieces that allow plate 70 to extend and retract via a biasing device, such as a spring, thereby providing flexibility to plate 70 in accommodating a variety of brake pedal sizes.

As internal pressure from fluid chamber 58 moves brake actuator shaft 62 away from fluid chamber head 65, brake actuator shaft 62, which is attached to pedal clamp structure 68 configured to be clamped to the towed vehicle's brake pedal, depresses or actuates the brake pedal thereby allowing the towed vehicle to decelerate or stop.

In at least one embodiment, ABD 20 also includes a brake actuator retraction system 79 (hereinafter referred to as “BARS”) configured to retract brake actuator 30 to allow the towed vehicle to accelerate along with the towing vehicle. BARS 79 may include an exhaust port 78 and an exhaust valve (not shown) that is in fluid communication with fluid chamber 58 via a vent port 81 on fluid chamber 58.

BARS 79 may be in communication with controller 44 and may include a second regulator 73. Second regulator 73 may be in communication with fluid reservoir 54. Fluid reservoir 54 may be configured to provide fluid pressure to second regulator 73 and to fluid cylinder or chamber 58 through lines 75 and 71 respectively.

Fluid pressure may be received at the end of fluid chamber 58 that is adjacent to shaft bushing 66 so that fluid preferably travels in the direction toward fluid chamber head 65 thereby causing brake actuator shaft 62 to retract. In at least one embodiment, second regulator 73 is configured to supply 7 psi of fluid pressure to fluid chamber 58 to bias brake actuator shaft 62 to a retracted position. This pressure may be maintained whenever ABD 20 is active, and must be overcome in order to activate the brakes of the towed vehicle. Accordingly, when a residual pressure, such as the 7 psi, is applied, first regulator 46 must apply the residual pressure in addition to the desired braking pressure in order to apply the desired braking pressure.

Controller 44 is preferably configured to detect a change in momentum of the towed vehicle caused by the acceleration of the towing vehicle 24 (FIG. 1) and convert said change in momentum to an electrical signal. Controller 44 may send the electrical signal to BARS 79 and cause BARS 79 to open exhaust port 78 and vent port 81, thereby allowing fluid from fluid chamber 58 to exit or bleed off. Alternatively, a fluid reservoir (not shown) could be provided to store excess fluid. Such a fluid reservoir would be useful if it is undesirable to bleed off excess fluid, such as if liquid fluids are used.

The internal pressure that extends brake actuator shaft 62 toward the towed vehicle's brake pedal subsequently decreases, thereby allowing brake actuator shaft 62 to retract toward fluid chamber head 65 with the aid of the 7 psi of pressure controlled by second regulator 73. When brake actuator shaft 62 is retracted, the braking power of the towed vehicle is reduced, and towed vehicle 22 may accelerate with towing vehicle 24.

Referring next to FIG. 4, external components of at least one embodiment of ABD 20 are depicted. ABD 20 may comprise a housing 28, which encases the interior components of ABD 20. A brake actuator 30 may protrude from housing 28. Brake actuator 30 may be configured to depress the brake pedal 26 of towed vehicle 22 (FIG. 1) when appropriate. A handle 32 may be coupled to housing 28 to allow users to conveniently transport or hold ABD 20.

Housing 28 may comprise a panel 41 on which buttons, lights, gauges, and connectors to possibly facilitate its operation and coordination with other related devices are mounted. Buttons that could be mounted on panel 41 could include a vent button 31, test button 33, a maximum brake pressure button 35, and a brake sensitivity button 37.

Vent button 31 that could be mounted on the housing 28 may be provided to allow a user to manually bleed or reduce the pressure within one or more components of the invention. Vent button 31 may be particularly useful in releasing any residual pressure within fluid chamber 58 that causes brake actuator 30 to ride on a vehicle's brake pedal, thereby allowing the user to move the vehicle. Vent button 31 may also be used to vent the residual pressure applied by second regulator 73.

Test button 33 that could be mounted on housing 28 could be used for testing communications between receiver unit 11 and transmitter unit 9 (FIG. 1) of the brake monitoring system. Maximum brake pressure button 35 and brake sensitivity button 37 that could mounted on housing 28 could be used simultaneously to calibrate the ABD 20 to the level position of towed vehicle 22 needed for proper operation of the invention.

Maximum brake pressure button 35 and brake sensitivity button 37 could also be used to set the pressure setting that would dictate the range of pressure that brake actuator 30 would be able to supply to brake pedal 26 (FIG. 1) of towed vehicle 22. The range of pressure that brake actuator 30 would supply to brake pedal 26 may be based on the brake pedal force required to stop towed vehicle 22, which may be based on the weight of towed vehicle 22. Other factors may also be considered in determining the range of pressures, such as the braking capacity of towing vehicle 24 or the road surface on which the towing vehicle 24 and towed vehicle 22 will be traveling.

Maximum brake pressure button 35 and brake sensitivity button 37 could be also possibly be used in conjunction with a set of maximum brake pressure lights 39 and a set of brake sensitivity lights 38, both sets of lights could be mounted on housing 28. The sets of lights could allow the user to see the pressure settings for invention as maximum brake pressure button 35 and brake sensitivity button 37 are respectively activated.

In at least one embodiment, a pressure gauge 40 that could be mounted on the housing could be used for indicating fluid pressure of one or more components of the invention could be mounted on the housing 28. The pressure gauge display 40 may be provided and positioned on housing 28 to allow the user to see the pressure setting for brake actuator 30 and to adjust the working pressure of ABD 20.

Connectors could be mounted on the housing 28 could be a set of first attachment points 34 and a second attachment point 36. The set of first attachment points 34 may be configured to receive a monitoring system (not shown). The monitoring system is described further below. Second attachment point 36 may be configured to receive a signal from break away system 14 (FIG. 1) described below.

In one embodiment, break away system 14 is a device that is connected to the hitch attachment 4 (FIG. 1). In the event that towed vehicle 22 (FIG. 1) is separated from towing vehicle 24 (FIG. 1), break away system 14 will generate a signal causing ABD 20 to activate, thereby causing towed vehicle 22 to stop. Break away system 14 may be any suitable device for detecting separation of towed vehicle 22 from towing vehicle 24. The resultant signal indicating a break away condition may be communicated to the ABD 20 in any suitable manner, such as, but not limited to, a radio frequency or RF signal or a signal communicated over wire. The break away condition may then be transmitted to receiver unit 11 (FIG. 1), alerting the driver of towing vehicle 24 to the condition.

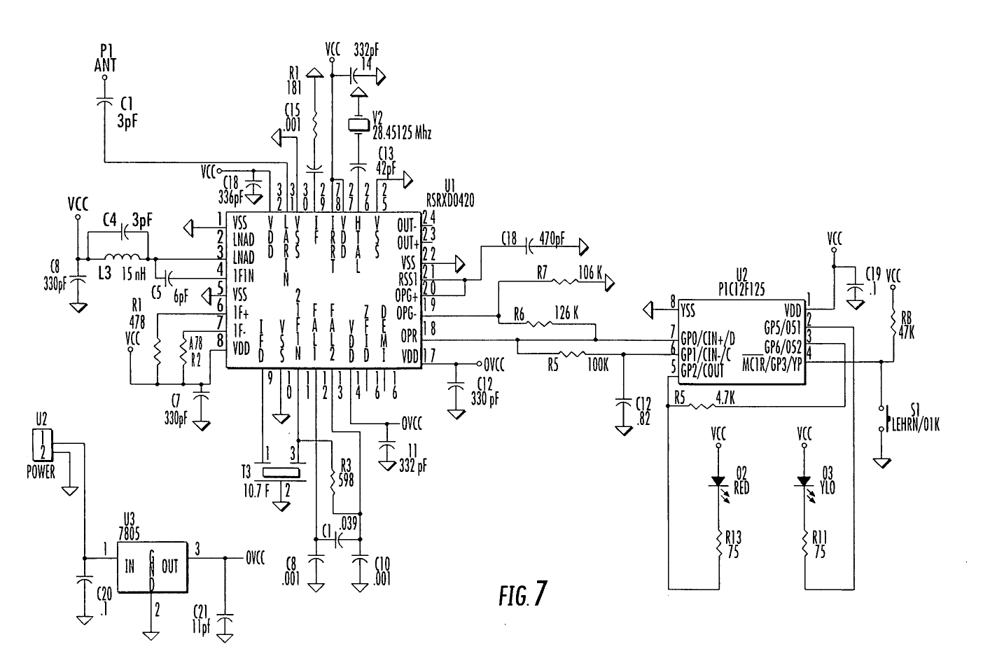

FIG. 6 is a block diagram of components of an embodiment of brake monitoring system 16, which includes auxiliary brake system 10 (FIG. 1). Brake monitoring system 16 may include receiver unit 11 and transmitter unit 9. Transmitter unit 9 may reside within ABD 20 (FIG. 1) or may be separate from, but operatively coupled to, ABD 20. This embodiment may include optional break away system 14.

Transmitter unit 9 may include a transceiver 602, processor 604, memory 606, and an operation detector 608. As used herein, a “transceiver” may be a device that may function as both a transmitter and receiver. However, it is to be understood that the present invention does not require transceivers and that the transceivers may be replaced by a transmitter or receiver, as appropriate.

A portion of memory 606 may store a suitable identifier 610 that identifies the transmitter unit 9. Operation detector 608 is configured to detect operation of the selected components of ABD 20. If all selected components are properly operating, operation detector 608 communicates a signal to processor 604 indicating proper operation. If one or more of the selected components are not properly operating, a corresponding signal is communicated to processor 604. The signal received from operation detector 608 is processed by processor 604 into a suitable signal that is communicated to transceiver 602. Transceiver 602 broadcasts a corresponding RF signal 612 that is received by receiver unit 11, thereby indicating that all selected components are operating properly or that one or more selected components are not properly operating.

Receiver unit 11 may include a transceiver 618, processor 620 and memory 622. One embodiment comprises at least a first indicator or lamp 624, and a dimming actuator 626. Other components described herein below may be included in other embodiments. RF signal 612 is received by transceiver 618, and a corresponding signal generated by transceiver 618 is communicated to processor 620 for processing.

In one embodiment, part of the received RF signal 612 is the above-described identifier 610 stored in memory 606 that identifies transmitter unit 9. A corresponding identifier 628 is stored in memory 622. The received identifier 610 is compared with the identifier 628 saved in memory 622. If the identifiers 610 and 628 correspond, receiver unit 11 understands that it was the intended recipient of the RF signal 612.

A portion of the received RF signal 612 includes information corresponding to the signal from operation detector 608. In embodiments having first lamp 624, if the selected components in ABD 20 are properly operating, first lamp 624 is illuminated such that a driver of towing vehicle 24 understands that ABD 20 is properly operating. If RF signal 612 includes information indicating that one or more selected components in ABD 20 are not properly operating, a second indicator or lamp 630 may be illuminated, indicating that one or more components of ABD 20 are not properly operating. In another embodiment, first lamp 624 is illuminated differently, such as with another color, to indicate to the driver that one or more components of ABD 20 are not properly operating. In at least one embodiment, first lamp 624 (or another lamp) is illuminated every time brake pedal 26 (FIG. 1) in towing vehicle 22 (FIG. 1) is actuated, so long as ABD 20 is operating properly. In this way, the driver of towing vehicle 24 (FIG. 1) is provided with positive feedback concerning the status of ABD 20 every time he or she brakes towing vehicle 22.

In one embodiment, the dimming actuator 626 is employed. When actuated at a first illumination level or brightness, lamp 624 (and other lamps) is illuminated at an intensity that is visible during high ambient light conditions, such as during a bright sunny day. When actuated at a second illumination level or brightness, first lamp 624 (and other lamps) is illuminated at an intensity that is visible during low ambient light conditions, such as at nighttime. Dimming actuator 626 may be any suitable controller, such as, but not limited to, a toggle switch, a push button or the like. In embodiments such as those employing a display screen (not shown), the functionality of dimming actuator 626 may be implemented through a menu system.

In embodiments employing break away system 14, transmitter unit 9 includes a break away signal detector 640 to detect signals from break away system 14. Break away system 14 may comprise a break away detector 632 and a break away signal generator 634. Break away detector 632 may be any suitable detector or detection system configured to detect separation of towed vehicle 22 from towing vehicle 24.

For example, one embodiment employs a simple connector 363 that detects physical loss of connectivity between towed vehicle 22 and towing vehicle 24. Connector 363 is physically coupled to a suitable location on towing vehicle 24 with a flexible attachment 638. Attachment 638 may be implemented with a wire, cord, cable, chain, rope, string or other suitable connection means. Flexibility provides for convenient coupling to towing vehicle 24 and allows for movement during the towing process. Similarly, a flexible attachment 641 provides coupling between towed vehicle 22 and connector 363. During a separation condition, separation of connector 363 is detected by break away detector 632. Other embodiments may employ more sophisticated separation detector systems.

If break away detector 632 detects separation of towed vehicle 22 from towing vehicle 24, break away signal generator 634 generates a corresponding signal that indicates the separation. Alternatively, the separation may be indicated by the interruption of a signal, such as the interruption of a circuit, a blown fuse, or similar mechanism. The separation signal, or signal interruption, is communicated to break away signal detector 640. In one embodiment of break away signal generator 634, a transceiver 642 is used to generate a first separation signal 644 communicated to transceiver 602 as an RF signal. Upon receiving separation signal 644, the transmitter unit 9 understands the occurrence of a separation event. Accordingly, a braking signal is generated and communicated such that the ABD 20 initiates a braking action of the towed vehicle 22. In one embodiment, separation signal 644 includes an identifier corresponding to identifier 610 so that other signals received by transceiver 602 do not generate a “false” braking signal.

In one embodiment, transceiver 642 generates a second separation signal 646 as an RF signal. Second separation signal 646 is received by transceiver 618. Upon receiving the second separation signal 646, at least one suitable indicium is communicated such that a driver of towing vehicle 24 understands that a break away condition has occurred. For example, without limitation, one of the above-described lamps 624, 630 or an Nth indicator or lamp 650 may be illuminated. In another embodiment, an audible warning sound may be generated by a speaker 648 or other suitable indicator or sound-generating device.

Upon receiving the separation signal, the break away signal detector 640 communicates with processor 604 such that processor 604 initiates a braking action of the towed vehicle 22 in accordance with embodiments of the present invention.

Testing of break away system 14 may be automatically initiated at power up in one embodiment. In another embodiment, the testing may be initiated by the driver by pulling a ring (not shown) on the break away device that simulates a break away, or separation, condition. Another embodiment comprises a test device (not shown) that simulates a separation condition. First lamp 624 remains illuminated until the break away system ring is returned or the test device is reset.

Alternative embodiments of transmitter unit 9 may further comprise one or more auxiliary detectors 652 that detect various conditions of towed vehicle 22 or towing vehicle 24. Other embodiments may include an auxiliary detector signal receiver 654 configured to receive signals from one or more remote detection devices (not shown). For example, conditions of the towed vehicle 22 or towing vehicle 24 may include a satellite dish that is not in a retracted and/or secured position, an electric step that is not retracted, compartments or doors open, or other useful warnings. When such a condition is detected by auxiliary detector 652, and/or when a remote detector (not shown) detects such a condition and communicates a signal to the auxiliary detector signal receiver 654, the condition is indicated to processor 604 via a suitable communication signal. Processor 604 then processes the received signal and causes transceiver 602 to broadcast the detected condition to receiver unit 11 via RF signal 612. When RF signal 612, indicating the detected condition is received by transceiver 618, at least one suitable warning indicium is then communicated to the driver of towing vehicle 24. For example, an Nth lamp 650 may be illuminated. In other embodiments, an audible warning signal may be provided.

In one embodiment, receiver unit 11 is configured to recognize that transmitter unit 9 has been replaced with a replacement transmitter unit (not shown) which may be similar to transmitter unit 9. The replacement transmitter unit includes another identifier residing in its memory. Actuating the dimming actuator 626 or another suitable controller, in one embodiment, for a predefined time causes processor 620 to recognize that a new identifier for a replacement transmitter unit is to be received. For example, but not limited to, the dimming actuator 626 is pressed for approximately six seconds to initiate the process of receiving an identifier from a replacement transmitter unit. First lamp 624 may periodically flash indicating that receiver unit 11 is ready to learn new identifiers for the replacement transmitter unit. In another embodiment, lamp 624 may illuminate if no identifiers 628 reside in memory 622, thereby indicating that at least one transmitter unit identifier is needed. Transceiver 618 then receives an RF signal from the replacement transmitter unit such that an identifier corresponding to replacement transmitter unit is saved into memory 622.

Furthermore, in an alternative embodiment, multiple transmitter units (not shown), which may be similar to transmitter unit 9, may be used. This embodiment may be desirable in a situation where multiple towed vehicles 22 are towed by the towing vehicle 24. Or, such an embodiment may be desirable when a fleet of towing vehicles 24 is towing a plurality of different towed vehicles 22 at different times. Accordingly, a plurality of transceiver unit identifiers 628 may be saved into memory 622. When an RF signal 612 is received, the plurality of identifiers are cycled through to see if the identifier in the received RF signal corresponds to one of the currently active identifiers 628 saved in memory 622.

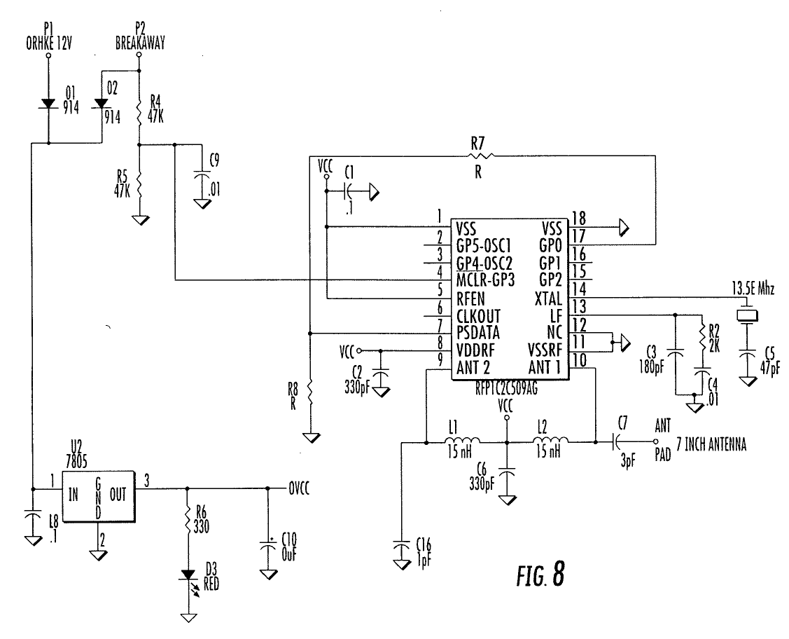

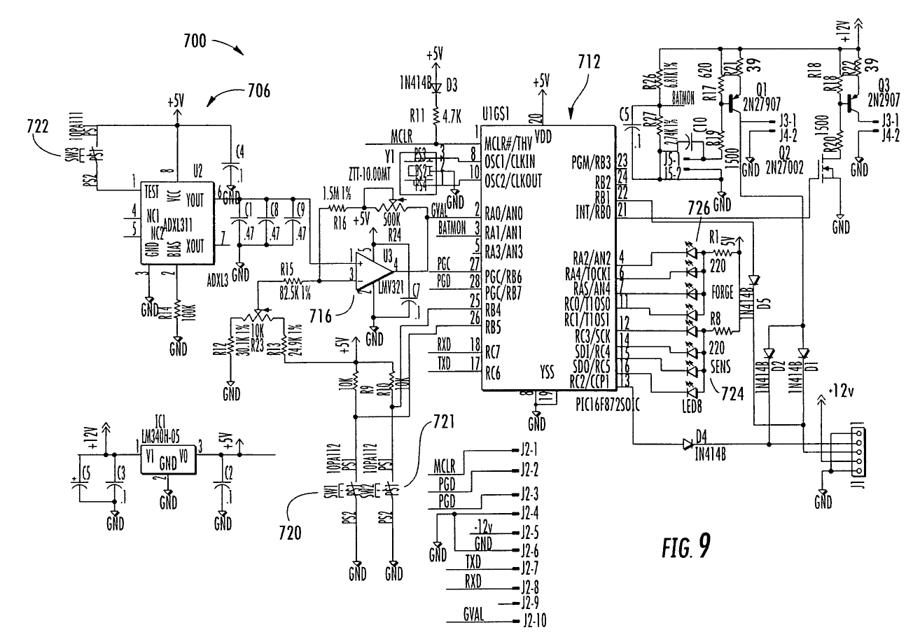

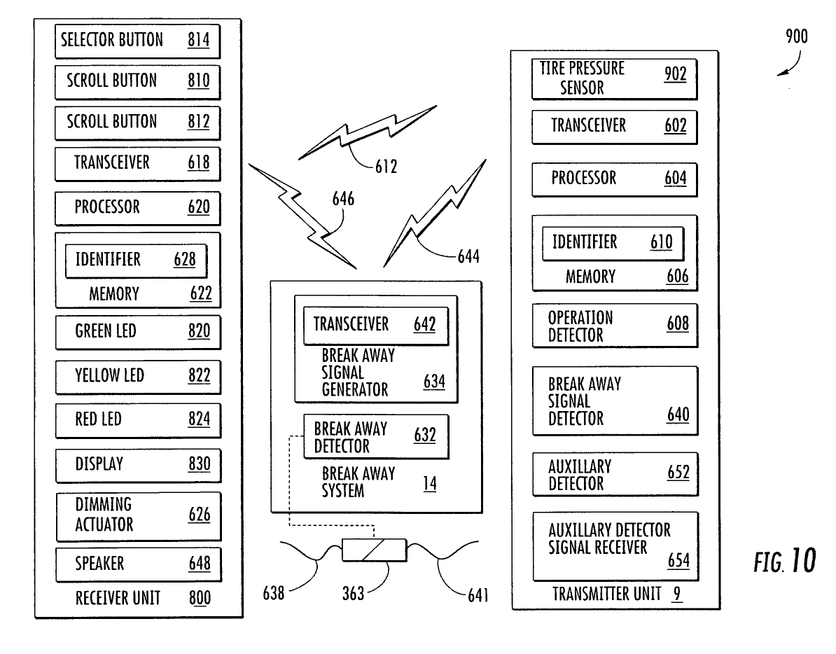

It is understood that transceivers 602, 618 and 642 may be any suitable RF communication device. Accordingly, transceivers, transmitters and/or receivers may be employed by embodiments of the present invention. For convenience, a detailed explanation of RF transceiver operation and construction are not provided herein since it is understood that any suitable RF transceiver, transmitter and/or receiver now known or later developed may be employed by embodiments of the present invention. However, circuit diagrams for one suitable receiver and one suitable transmitter are illustrated in FIGS. 7 and 8, respectively.

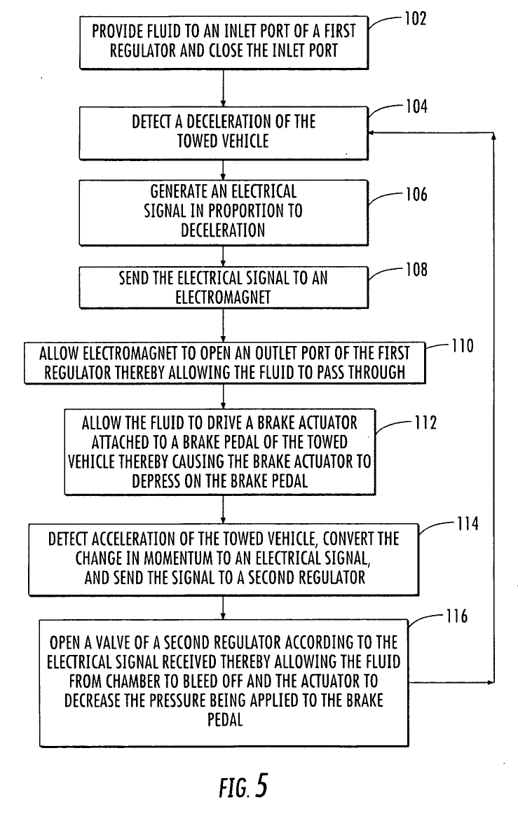

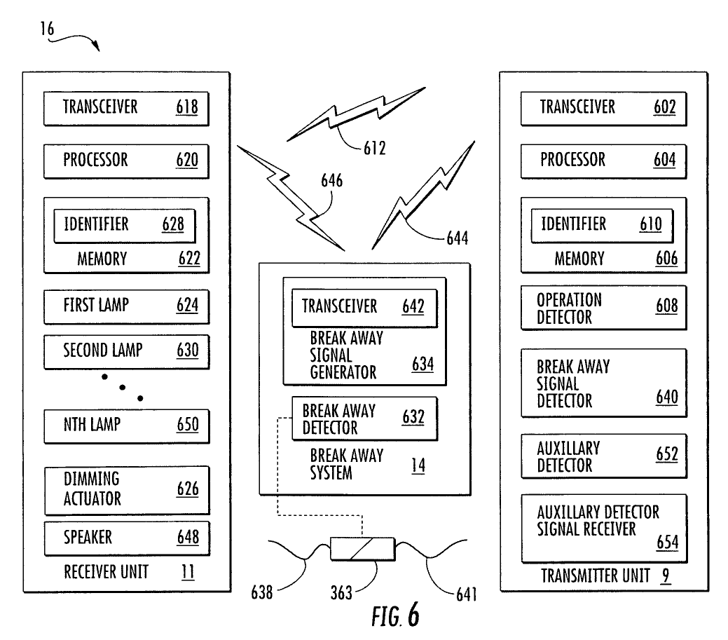

Referring now to FIGS. 2 and 5, in one embodiment, ABD 20 operates in the following manner. At step 102, when cigarette lighter adaptor 42 is connected to the towed vehicle's battery (not shown), air compressor 60 is turned on. Air compressor 60 may then generate and supply fluid, e.g. air, to fluid reservoir 54 via a first fluid connector 63. Air from fluid reservoir 54 is carried through a second fluid connector 67 leading to input port 52 of first regulator 46. In at least one embodiment, input port 52 allows air to be supplied to fluid reservoir 54 at a constant pressure, such as, but not limited to, approximately 27 psi. Input port 52 closes once the constant pressure in fluid reservoir 54 is achieved.

At step 104, controller 44 detects deceleration of the towed vehicle. At step 106, controller 44 converts the a change in the momentum of the inertial sensor, which may be correlated to the momentum change of towed vehicle 22, and generates an electrical signal proportional to the change in momentum. The electrical signal is of a particular unit, which is preferably in voltage, though any suitable signal such as a current or a digital signal is employed in alternative embodiments. At step 108, controller 44 may communicate the electrical signal through an electrical wire to first regulator 46. The electrical signal provides power to electromagnetic coil 90 (FIG. 3B) of first regulator 46 and powers valve actuator member 80 (FIG. 3B). At step 110, valve actuator member 80 causes a valve control mechanism, such as plunger 89 (FIG. 3A), to move from a position blocking the air passage between input port 52 and output port 56 to a position that allows air to pass through the passage and exit through outlet port 56. Other embodiments communicate other suitable forms of signals corresponding to a sensed inertial change via any suitable communication medium, including, but not limited to, radio frequency, infrared, laser or visible light.

At step 112, air exiting through outlet port 56 is carried to fluid chamber 58 and causes an increase in the existing pressure in fluid chamber 58. The increase in fluid pressure drives brake actuator shaft 62 of brake actuator 30 away from fluid chamber 58. Brake actuator shaft 62, which is configured to be coupled to the brake pedal 26 of towed vehicle 22 (FIG. 1), consequently depresses brake pedal 26, thereby causing towed vehicle 22 to slow down or stop.

At step 114, when towing vehicle 24 accelerates again, controller 44 positioned within towed vehicle 22 may detect the acceleration. Controller 44 may correlate this to the change in momentum caused by the acceleration, generates a corresponding electrical signal, and communicates the electrical signal to second regulator 73. Second regulator 73 may be coupled to fluid chamber 58 via line 71. At step 116, an electrical signal may cause an exhaust valve at a vent port 81 of second regulator 73 to open, thereby allowing air to vent out or bleed. When air vents out, a decrease in air pressure within fluid chamber 58 occurs. The decrease in air pressure and the 7 psi of pressure controlled by second regulator 73 allows brake actuator shaft 62 to move toward fluid chamber head 65. When brake actuator shaft 62 moves toward fluid chamber head 65, the pressure applied by brake actuator shaft 62 to brake pedal 26 of towed vehicle 22 is reduced, thereby allowing towed vehicle 22 to accelerate along with towing vehicle 24.

With reference to FIG. 9, one embodiment of controller 44, generally indicated by reference numeral 700 is now described. Controller 44 is shown with an accelerometer 706, a microprocessor 712, an operational amplifier 716, switches 720 and 721, and two panels of light emitting diodes (LED's) 724 and 726. These components are arranged on, or operatively connected to, a printed circuit board.

Controller 44 may be provided with a number of switches 720, 721 and 722 by which a user may provide input to controller 44. One of switches 720 or 721 may be provided to generally refer to maximum brake pressure button 35. One of switches 720 or 721 may be provided to generally refer to brake sensitivity button 37. Switch 722 may be provided to generally refer to test button 33. In conjunction with switches 720 and 721 are panels 724 and 726, having four LEDs each, which generally reference the set of maximum brake pressure lights 39 and the set of brake sensitivity lights 38.

Switches 720 and 721 may be used to set a threshold level of duration and/or intensity of deceleration needed to activate ABD 20. Switches 720 and 721 may also be used to control the rate at which braking force is increased. In at least one embodiment, a user is capable of setting the sensitivity of a plurality, such as four, settings. Each time the user presses a switch, the sensitivity setting may increment to the next highest setting. When the highest setting is reached, additional activations of the switch may cause the controller 44 to cycle or wrap back to the lowest sensitivity setting.

The accelerometer 706 may be a model ADXL 311 accelerometer available from Analogue Devices, Inc. As shown in FIG. 9, the accelerometer 706 is supplied with a voltage V1 and has a quiescent output of one-half V1. When the accelerometer 706 detects a deceleration, the output increases, such as by about 200 millivolts. The accelerometer 706 may be in communication with an operational amplifier 716, which may be a model U-3. The operational amplifier 716 may be used to scale the output from the accelerometer such that 1 g (1 times the force of gravity) of deceleration will provide full scale input to an analog-to-digital converter in the microprocessor.

Microprocessor 712 may be provided with algorithms that use the sensitivity and force settings, as well as the rate of deceleration determined by accelerometer 706, to generate a pulse width modulated signal. The signal may be used to provide a variable voltage to electromagnetic coil 90 (FIGS. 2, 3A, and 3B). The strength of the signal determines how much force is applied to brake pedal 26 of towed vehicle 22 (FIG. 1).

A delay time factor may be used to help prevent false triggers of ABD 20, for example, going over a railroad track. The delay time factor may require accelerometer 706 to sense the deceleration of a threshold amount for a certain time period before transmitting signals to activate ABD 20. This delay time factor may be the same for all sensitivity settings, or may be appropriately adjusted for different levels of sensitivity. For example, higher levels of sensitivity may have a smaller delay time factor.

Switches 720 and 721 may determine the amount of force that may be applied to brake pedal 26 of towed vehicle 22, and the maximum braking force for each level of sensitivity. The pressure level may be set by the user in a similar manner to the sensitivity level. The pressure level may be controlled by adjusting the amount of voltage applied to electromagnetic coil 90.

In at least one embodiment, when the sensitivity setting is set by the user at a relatively low setting, controller 44 will automatically increase the maximum force that will be applied. In this way, ABD 20 applies a stronger force to brake pedal 26 of towed vehicle 22 to compensate for brake pedal 26 not being activated as quickly as when the sensitivity threshold is reduced.

In certain situations, it may be desirable to temporarily override the user defined force setting. For example, sudden drastic changes in velocity may require braking forces that exceed the user's set pressure level. In this case, controller 44 may be set to monitor the change in gravity (g-force) over time. If the change is excessive, more than would occur during a normal, gradual change in velocity, ABD 20 may be allowed to apply the maximum braking force it is capable of, regardless of the pressure setting.

Controller 44 may be provided with a calibration of the level feature in order to improve the accuracy of the accelerometer. The calibration routine may be activated by the user, such as when the user activates both switches 720 and 721 at the same time. Activation of the calibration feature allows the unit to determine a slope value and add it to a table of stored values.

In certain embodiments, controller 44 is configured to periodically check the battery level of towed vehicle 22. If the battery level falls below a certain level, such as 10.5 volts, a warning signal may be transmitted to receiver unit 11 (FIG. 1), which causes an LED to flash. The warning signal could be communicated to the operator by the activation of a specific indicator (e.g., the flashing of the first lamp 624 every five seconds) or other suitable means to alert the operator to the low battery condition. In certain embodiments, ABD 20 may be disabled if the battery falls below a certain threshold, such as 9 volts.

Controller 44 may also be provided with a test feature in order to assure the user that the components of controller 44 are functioning properly. When the test function is activated, such as by a switch or a combination of switches, an output of about 200 millivolts may be sent from the accelerometer to be processed by the electronics of ABS 10, including controller 44. If the unit is functioning properly, the user will observe braking and control signals. In another embodiment, the testing may be initiated by the driver by pressing down on brake pedal 26, and holding brake pedal 26 in the down position until first lamp 624 remains illuminated. First lamp 624 remains illuminated until released. Testing the operation of components in the ABD 20 may also be initiated at power up. Those of skill in the art will recognize that the above functions may be implemented in a variety of ways.

It can thus be appreciated that certain embodiments of ABD 20 provide an auxiliary brake system 10 for towed vehicle 22 that is reactive to the speed of towing vehicle 24. Certain embodiments of ABD 20 have the ability to depress brake pedal 26 of towed vehicle 22 using a pressure that is substantially proportional to the detected change in momentum caused by the deceleration and acceleration of towing vehicle 24. In doing so, towing vehicle 24 benefits by virtue of the towed vehicle's brakes relieving the towing vehicle's brakes from excessive wear.

Towed vehicle 22 also benefits by having an auxiliary brake system 10 that activates the towed vehicle's brakes with only the necessary pressure required to slow down towed vehicle 22. The towed vehicle 22 further benefits from the quick retraction system of ABD 20, which quickly allows towed vehicle 22 to accelerate with towing vehicle 24. Thus, the likelihood of ABD 20 to constantly depress or “ride” on the towed vehicle's brakes while being accelerated by towing vehicle 24 is minimized. The likelihood of the towed vehicle's brakes to overheat is consequently minimized.

It can also be appreciated that certain embodiments of ABD 20 provide a portable auxiliary braking device 20 that may be used for any vehicle type. Alternative embodiments provide an auxiliary braking device 20 that works with vehicles having an ABS system, an auxiliary braking device that does not require tapping into the brake lines of the towed vehicle, an auxiliary braking device that can easily be set-up and operated, and an auxiliary braking device that does not void the towed vehicle's manufacturer's warranty.

In certain embodiments, the present invention provides a brake monitoring system. The brake monitoring system may provide feedback to the driver of a towing vehicle that the braking system of the towed vehicle is properly functioning. In addition, the brake monitoring system may alert the driver to problems with the brake system of the towed vehicle.

### Alternative Embodiment

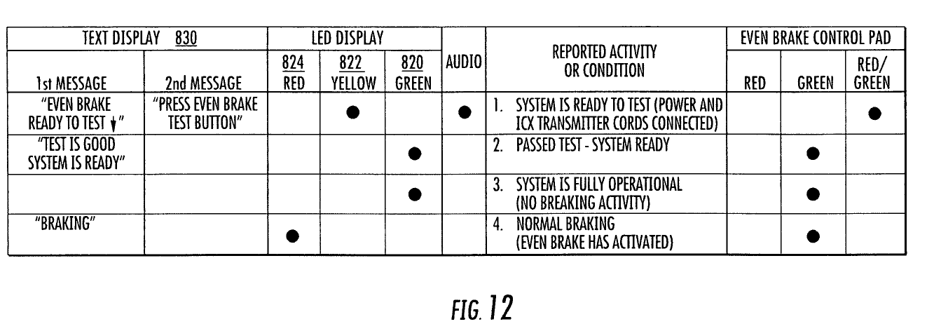

Turning now to FIG. 10, an alternative embodiment of components for an auxiliary brake system using a display is shown. FIG. 10 is a block diagram of components of an embodiment of brake monitoring system 900. Brake monitoring system 900 may include receiver unit 800 and transmitter unit 9. In FIG. 10, receiver unit 800 replaces the receiver unit 11 of FIG. 6. In FIG. 10, transmitter unit 9 includes a tire pressure sensor 902 that can sense the tire pressure of a towed vehicle.

Transmitter unit 9 may reside within ABD 20 (FIG. 1) or may be separate from, but operatively coupled to, ABD 20. This embodiment may include optional break away system 14. Transmitter unit 9 can be the same as previously described for FIG. 6.

Transceiver 602 broadcasts a corresponding message or RF signal 612 that is received by the receiver unit 800 about system operating parameters, thereby indicating that all selected components are operating properly or that one or more selected components are not properly operating. Processor 604 may receive information about one or more operating parameters of auxiliary braking device 20. Processor 604 may generate messages about the one or more operating parameters that may be transmitted via transceiver 602 to receiver unit 800.

Alternatively, the operating parameters may be transmitted on a signal via transceiver 602 to receiver unit 800, where a message may be generated.

Receiver unit 800 may include a transceiver 618, processor 620 and memory 622. One embodiment comprises at least green light emitting diode (LED) 820, yellow LED 822 red LED 824, selector button 814 and scroll buttons 810 and 812. Receiver unit 800 can further include a dimming actuator 626, speaker 648 and display 830. Display 830 is an alpha-numeric display that can display messages about operating parameters of the auxiliary brake system 10.

Processor 620 is in communication with and can control transceiver 618, memory 622, LED's 820, 822, 824, dimming actuator 626 and display 830. Software would reside within memory 622 and be operative on processor 620 in order to control the function and operation of receiver unit 800. The software can be any type of software that is known in the art for controlling processors.

RF signal 612 is received by transceiver 618, and a corresponding signal generated by transceiver 618 is communicated to processor 620 for processing.

In one embodiment, part of the received RF signal 612 is the previously described identifier 610 stored in memory 606 that identifies transmitter unit 9. A corresponding identifier 628 is stored in memory 622. The received identifier 610 is compared with the identifier 628 saved in memory 622. If the identifiers 610 and 628 correspond, receiver unit 800 understands that it was the intended recipient of the RF signal 612.

A portion of the received RF signal 612 includes information corresponding to the signal from operation detector 608. If the selected components in auxiliary braking device 20 are properly operating, processor 620 can illuminate the green LED 820 such that a driver of towing vehicle 24 understands that ABD 20 is properly operating. Yellow LED 822 can be lit to indicate a condition that is a concern or should be checked by the driver. If RF signal 612 includes information indicating that one or more selected components in ABD 20 are not properly operating, red LED 824 may be illuminated, indicating that one or more components of ABD 20 are not properly operating.

In at least one embodiment, red LED 824 can be illuminated every time brake pedal 26 (FIG. 1) in towed vehicle 22 (FIG. 1) is actuated, so long as ABD 20 is operating properly. In this way, the driver of towing vehicle 24 (FIG. 1) is provided with positive feedback concerning the status of ABD 20 every time he or she brakes towing vehicle 24.

In one embodiment, a dimming actuator 626 is employed. Dimming actuator is in communication with LED's 820, 822 and 824 and display 830. When actuated at a first illumination level or brightness, the display 830 and LED's are illuminated at an intensity that is visible during high ambient light conditions, such as during a bright sunny day. When actuated at a second illumination level or brightness, the display 830 and LED's are illuminated at an intensity that is visible during low ambient light conditions, such as at nighttime. Dimming actuator 626 may be any suitable controller, such as, but not limited to, a toggle switch, a push button or the like.

In embodiments employing break away system 14, transmitter unit 9 includes a break away signal detector 632 to detect signals from the break away system 14. Break away system 14 may comprise a break away detector 632 and a break away signal generator 634. Break away detector 632 may be any suitable detector or detection system configured to detect separation of towed vehicle 22 from towing vehicle 24.

Embodiments of the present invention may further comprise one or more auxiliary detectors 652 that detect various conditions of towed vehicle 22 or towing vehicle 24. Other embodiments may include an auxiliary detector signal receiver 654 configured to receive signals from one or more remote detection devices (not shown). For example, conditions of the towed vehicle 22 or towing vehicle 24 may include a satellite dish that is not in a retracted and/or secured position, an electric step that is not retracted, compartments or doors open, or other useful warnings.

Other conditions or parameters may be sensed or monitored such as tire pressure of a towed vehicle using tire pressure sensor 902. Tire pressure sensor 902 can be a conventional tire pressure sensor. Preferably, tire pressure sensor 902 will be mounted with each tire of the towed vehicle. Other parameters that may be sensed include the tire pressure of a towing vehicle, battery voltage and operating status of various items in the towed vehicle such as a refrigerator.

When a condition or parameter is detected by auxiliary detector 652, and/or when a remote detector (not shown) detects such a condition and communicates a signal to the auxiliary detector signal receiver 654, the condition is indicated to processor 604 via a suitable communication signal. Processor 604 then processes the received signal and causes transceiver 602 to broadcast the detected condition to receiver unit 800 via RF signal 612. When RF signal 612 indicating the detected condition is received by transceiver 618, processor 620 instructs display 830 to show the appropriate condition message. One or more of LED's 820, 822 or 824 may be illuminated. An audible warning signal may be provided on speaker 648.

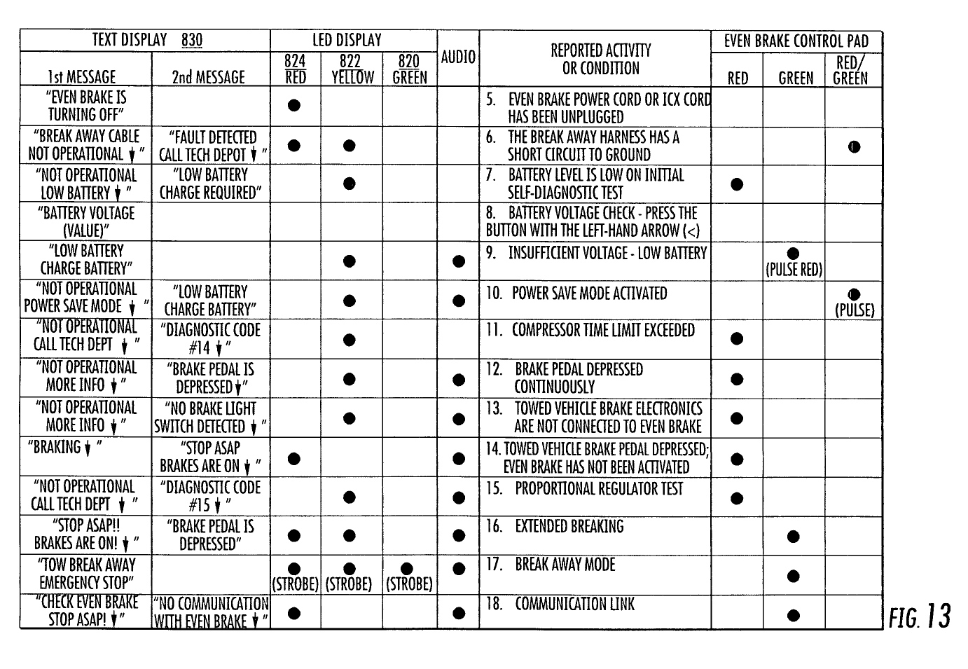

With reference to FIG. 11, a receiver unit or monitor 800 is shown. Receiver unit 800 can be affixed to a dashboard of a vehicle using a suitable fastener mechanism, such as Velcro, a strap, or a bracket. Receiver unit 800 may provide an indication to occupants of the towing vehicle that the auxiliary brake system 10 is functioning as intended and/or is not functioning as intended.

Receiver unit 800 may include a housing 802. A 12 volt power cable or cord 804 extends from housing 802 and can be connected to a 12 volt power source such as a vehicle power outlet. An antenna 806 extends from housing 802 and is used to receive signals from transmitter unit 9. A speaker 648 can be mounted in housing 800 for providing the vehicle operator with an audible indication of a vehicle braking condition.

Several buttons are mounted in housing 802 to allow the vehicle operator to make selections. Scroll buttons 810 and 812 and selector button 814 are mounted in housing 802. A green light emitting diode (LED) 820, yellow LED 822 and red LED 824 are mounted in housing 802. Light emitting diodes 820-824 provide the vehicle operator with a visual indication of a vehicle braking condition.

A display 830 is mounted in housing 802. Display 830 can be a wide variety of display types such as a liquid crystal display, a plasma display, an electroluminescent display, or a cathode ray tube. Display 830 can be an alpha-numeric display.

Display 830 provides the vehicle operator with additional information about the status and operation of various operating parameters of auxiliary brake system 10. Processor 620 (FIGS. 6 and 10) is in communication with display 830 and can generate a wide variety of system messages to show on display 830. Processor 620 functions with software that can generate the system messages.

Processor 620 can receive data through RF signal 612 in regards to an operating parameter sensed by auxiliary detector 652 (FIGS. 6 and 10). Processor 620 can generate a message from the operating parameter that can be displayed on display 830.

System Messages and Functions

With reference to FIG. 12, a chart of normal system status and condition messages about auxiliary brake system 10 that can be displayed by processor 620 on display 830 are shown. The messages are numbered with the number listed under the column labeled, “reported activity or condition”. In one embodiment, auxiliary brake system 10 can be given the name, “Even Brake”.

1. System is Ready to Test

After the auxiliary brake system 10, or Even Brake, has been installed and the ICX transmitter cord and the power cord are connected, the display 830 will read, “Even Brake ready to test ⇓”. An audio alert will accompany the message on speaker 648 and the yellow light emitting diode 822 will be illuminated. The alert stops when the right hand arrow button 812 is pressed. This monitor then scrolls to the second half of the message, which reads, “Press Even Brake test button”. The test button 33 is located on the housing 28 (FIG. 4).

2. Passed Test—System Ready

When the test button 33 is pressed, the braking system will run a self-diagnostic test. If the test indicates that the braking system is operational and ready to brake the towed vehicle, the display 830 displays, “Test is good system ready”. The green light emitting diode 820 will be illuminated.

3. System is Fully Operational

During normal towing operations, the green led 820 is continuously illuminated and display 830 will be blank. This indicates that the braking system is operational and ready to brake.

4. Normal Braking

During normal operation, when the braking system is activated, the display 830 will read, “Braking” and the red light emitting diode 824 will be illuminated. This indicates that the towed vehicle's brakes are being applied.

With reference now to FIG. 13, a chart of error condition messages that can be displayed on display 830 are shown. The messages are numbered with the number listed under the column labeled, “reported activity or condition”.

5. The System Power Cord or ICX Transmitter Cord has Been Unplugged.

If either the 12 volt power cord or the ICX transmitter cord, have been unplugged, the braking system will shut down until the cord is plugged back in. The red light emitting diode 824 will be illuminated and display 830 will read, “Even Brake is turning off”.

6. The Break Away Harness has a Short Circuit

During the self test program, the break away circuit is tested. If the break away circuit has a short circuit, display 830 will read, “Break Away Cable Not Operational ⇓”. The red LED 824 and yellow LED 822 will be illuminated. When the right hand arrow button 812 is pressed, the display monitor then scrolls to the second half of the message, which reads, “Fault Detected Call Tech Depth ⇓”. Additional messages may be shown on display 830.

7. Battery Level is Low on Initial Self-diagnostic Test

When there is insufficient voltage in the towed vehicle battery during self test, the braking system will not operate. The display 830 will read, “Not operational low battery ⇓”. When the right hand arrow button 812 is pressed, the display then scrolls to the second half of the message, which reads, “Low battery charge required”. The yellow LED 822 will be illuminated.

8. Battery Voltage Check

The voltage in the towed vehicle battery can be checked by depressing the left hand arrow 810 once. The display 830 will read, “Battery voltage (value)”. None of the LED's are lit.

9. Insufficient Voltage, Low Battery

When there is insufficient voltage in the towed vehicle battery during operation, the braking system will not operate. The display 830 will read, “Low battery charge battery”. An audio alert is also given on speaker 648. The yellow LED 822 will be illuminated.

10. Power Save Mode Activated

Before the voltage in the towed vehicle battery is completely depleted, the braking system enters a power saving mode. In the power save mode, the braking system will only operate during an emergency break away condition. The display 830 will read, “Not operational, Power Save mode ⇓”. An audio alert is also given on speaker 648. The yellow LED 822 will be illuminated. When the right hand arrow button 812 is pressed, the display then scrolls to the second half of the message, which reads, “Low battery charge battery”.

11. Compressor Time Limit Exceeded

During the self-diagnostics test, the time to fill the fluid reservoir is measured. If this time exceeds a pre-determined amount of time, an error message is displayed. The display 830 will read, “Not operational, call Tech Depth ⇓”. When the right hand arrow button 812 is pressed, the display then scrolls to the second half of the message, which reads, “Diagnostic code #14 ⇓”. The yellow light emitting diode 822 is illuminated. Additional messages may be shown on display 830.

12. Brake Pedal Depressed Continuously

As part of the initial self-diagnostics test, the towed vehicle's brake light switch is checked. If the brake light switch remains on, which indicates that the brake pedal is being continuously depressed, an error message is displayed. The display 830 will read, “Not operational more info ⇓”. When the right hand arrow button 812 is pressed, the monitor then scrolls to the second half of the message, which reads, “Brake pedal is depressed ⇓”. The yellow light emitting diode 822 is illuminated. An audio alert is also given on speaker 648. Additional messages may be shown on display 830.

13. Towed Vehicle Brake Electronics are not Connected

As part of the initial self-diagnostics test, the towed vehicle's brake light switch is checked. If there is no signal from the brake light switch, this indicates that the braking system electronics are not connected to the auxiliary brake system 10. The display 830 will read, “Not operational more info ⇓”. When the right hand arrow button 812 is pressed, the monitor then scrolls to the second half of the message, which reads, “No brake light switch detected ⇓”. The yellow light emitting diode 822 is illuminated. An audio alert is also given on speaker 648. Additional messages may be shown on display 830.

14. Towed Vehicle Brake Pedal Depressed, Braking System not Activated

When the towed vehicle brake pedal is depressed and the braking system is not activated, an error message is displayed. The display 830 will read, “Braking ⇓”. When the right hand arrow button 812 is pressed, the monitor then scrolls to the second half of the message, which reads, “Stop ASAP Brakes are on ⇓”. The red light emitting diode 824 is illuminated. An audio alert is also given on speaker 648. Additional messages may be shown on display 830.

15. Proportional Regulator Test

As part of the initial self-diagnostic test, auxiliary brake system 10 checks the proportional regulator. If the regulator is not functioning at full capacity, display 830 will read, “Not operational Call Tech Depth ⇓”. When the right hand arrow button 812 is pressed, the monitor then scrolls to the second half of the message, which reads, “Diagnostic code #15⇓”. The yellow light emitting diode 822 is illuminated. An audio alert is also given on speaker 648. Additional messages may be shown on display 830.

16. Extended Braking

After an extended period of continuous braking, the display 830 will read, “Stop, ASAP!! Brakes are ON ⇓!”. The vehicle should be stopped. When the right hand arrow button 812 is pressed, the monitor then scrolls to the second half of the message, which reads, “Brake pedal is depressed ⇓”. The red LED 824 and yellow LED 822 are illuminated. An audio alert is also given on speaker 648. Additional messages may be shown on display 830.

17. Break Away Mode

The towed vehicle has separated from the towing vehicle. Display 830 will read “TOW break away Emergency STOP.” The green LED 820, yellow LED 822 and red LED 824 will rapidly flash. An audio alert is also given on speaker 648. The auxiliary brake system 10 will apply maximum pressure to the towed vehicle's brakes to bring it to a stop.

18. Communication Link

A component of the communications system is not connected. The display 830 will read, “Check Even Brake stop ASAP! ⇓”. The red light emitting diode 824 will be lit. An audio alert is also given on speaker 648. When the right hand arrow button 812 is pressed, the monitor then scrolls to the second half of the message, which reads, “No communication with Even Brake ⇓”. Additional messages may be shown on display 830.

### Alternative Controller Embodiment

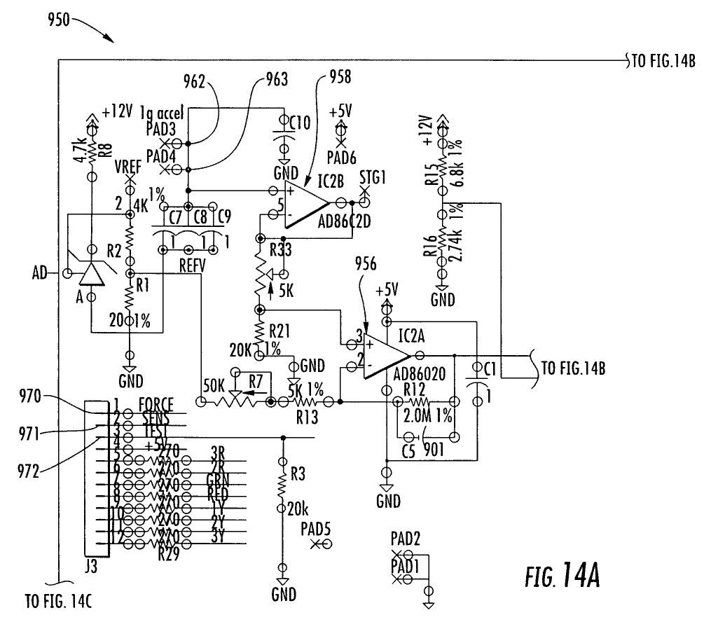

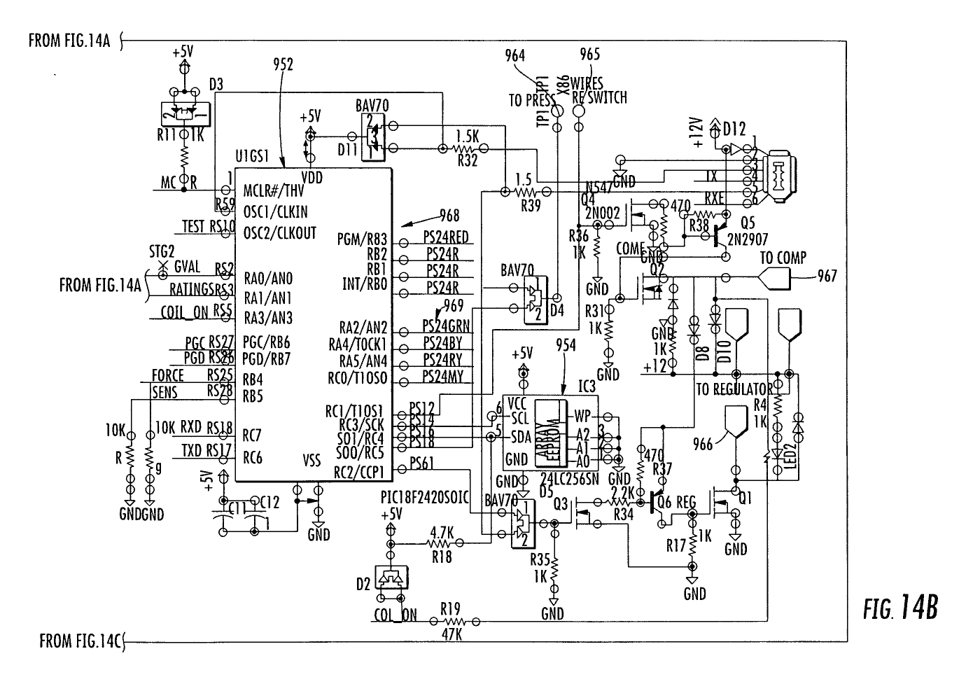

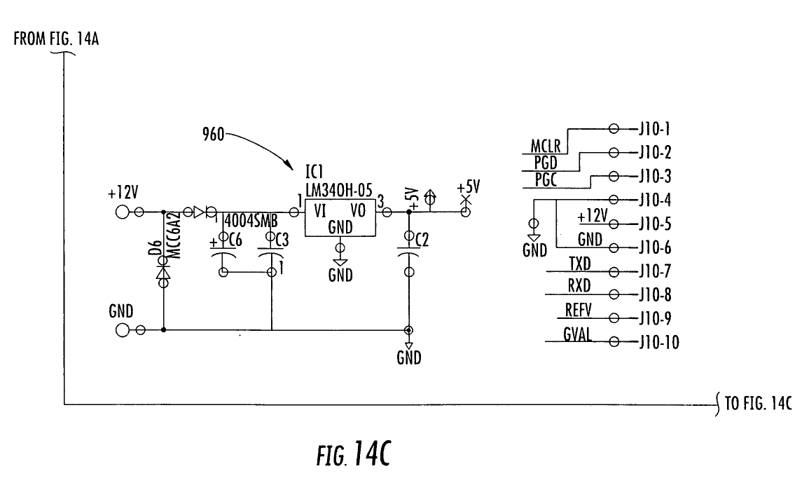

With reference to FIGS. 2, 4 and 14, an alternative embodiment of controller 44, generally indicated by reference numeral 950 for use with brake monitoring system 900 is now described. Controller 950 can include a microprocessor 952, a memory 954, operational amplifiers 956 and 958, and a 5 volt power supply 960. These components are arranged on, or operatively connected to, a printed circuit board (not shown).

Several terminals are mounted to the printed circuit board and are in electrical communication with controller 950. Terminals 962 and 963 can be connected to an accelerometer (not shown). Terminals 964 and 965 can be connected to a pressure switch 61 (FIG. 2). Terminal 966 can be connected to regulator 46 and terminal 967 can be connected to compressor 60. Terminals 968 and 969 can be connected with light emitting diodes which correspond to the set of maximum brake pressure lights 39 and the set of brake sensitivity lights 41. Terminal 970 can be connected to maximum brake pressure switch or button 35. Terminal 971 can be connected to the brake sensitivity switch or button 37. Terminal 972 can be connected to the test switch or button 33.

Switches 35 and 37 may be used to set a threshold level of duration and/or intensity of deceleration needed to activate ABD 20. Switches 35 and 37 may also be used to control the rate at which braking force is increased. In at least one embodiment, a user is capable of setting the sensitivity of a plurality, such as four, settings. Each time the user presses a switch, the sensitivity setting may increment to the next highest setting. When the highest setting is reach, additional activations of the switch may cause the controller 44 to cycle or wrap back to the lowest sensitivity setting.

The accelerometer (not shown) measures acceleration and deceleration of the vehicles. When the accelerometer detects a deceleration, the output voltage increases, such as by about 200 millivolts. The accelerometer is in communication with operational amplifier 958. The operational amplifier 958 may be used to scale the output from the accelerometer such that 1 g (1 times the force of gravity) of deceleration will provide full scale input to an analog to digital converter in the microprocessor.

Microprocessor 952 may be provided with algorithms that use the sensitivity and force settings, as well as the rate of deceleration determined by the accelerometer, to generate a pulse width modulated signal. The signal may be used to provide a variable voltage to electromagnetic coil 90 (FIGS. 2, 3A, and 3B). The strength of the signal determines how much force is applied to brake pedal 26 of towed vehicle 22 (FIG. 1).

Software to implement the algorithms may be stored in electrically erasable programmable read only memory (EEPROM) 954. EEPROM 954 is in communication with microprocessor 952.

A delay time factor may be used to help prevent false triggers of ABD 20, for example, going over a railroad track. The delay time factor may require the accelerometer to sense the deceleration of a threshold amount for a certain time period before transmitting signals to activate ABD 20. This delay time factor may be the same for all sensitivity settings, or may be appropriately adjusted for different levels of sensitivity. For example, higher levels of sensitivity may have a smaller delay time factor.

Switches 35 and 37 may determine the amount of force that may be applied to brake pedal 26 of towed vehicle 22, and the maximum braking pressure for each level of sensitivity. The pressure level may be set by the user in a similar manner to the sensitivity level. The pressure level may be controlled by adjusting the amount of voltage applied to electromagnetic coil 90.

In at least one embodiment, when the sensitivity setting is set by the user at a relatively low setting, controller 44 will automatically increase the maximum force that will be applied. In this way, ABD 20 applies a stronger force to brake pedal 26 of towed vehicle 22 to compensate for brake pedal 26 not being activated as quickly as when the sensitivity threshold is reduced.

In certain situations, it may be desirable to temporarily override the user defined force setting. For example, sudden drastic changes in velocity may require braking forces that exceed the user's set pressure level. In this case, controller 44 may be set to monitor the change in gravity (g-force) over time. If the change is excessive, more than would occur during a normal, gradual change in velocity, ABD 20 may be allowed to apply the maximum braking force it is capable of, regardless of the pressure setting.

Controller 44 may be provided with a calibration of the level feature in order to improve the accuracy of the accelerometer. The calibration routine may be activated by the user, such as when the user activates both switches 35 and 37 at the same time. Activation of the calibration feature allows the unit to determine a slope value and add it to a table of stored values.

In certain embodiments, controller 44 is configured to periodically check the battery level of towed vehicle 22. If the battery level falls below a certain level, such as 10.5 volts, a warning signal may be transmitted to receiver unit 800 (FIG. 10), which causes an LED to flash and the battery voltage can be displayed on display 830. In certain embodiments, ABD 20 may be disabled if the battery falls below a certain threshold, such as 9 volts.

In certain embodiments, controller 44 is configured to periodically check the tire pressure of the tires in towed vehicle 22. If the tire pressure level falls below a certain level, such as 30 pounds per square inch, a warning signal may be transmitted to receiver unit 800 (FIG. 10), which causes an LED to flash and the tire pressure can be displayed on display 830.

Controller 44 may also be provided with a test feature in order to assure the user that the components of controller 44 are functioning properly. When the test function is activated, such as by switch 33 through terminal 972, or a combination of switches, an output of about 200 millivolts may be sent from the accelerometer to be processed by the electronics of auxiliary brake system 10, including controller 44. If the unit is functioning properly, the user will observe braking and control signals. In another embodiment, the testing may be initiated by the driver by pressing down on brake pedal 26, and holding brake pedal 26 in the down position for a predetermined period of time. Testing the operation of components in the ABD 20 may also be initiated at power up. Those of skill in the art will recognize that the above functions may be implemented in a variety of ways.

In certain embodiments, the present invention provides a brake monitoring system. The brake monitoring system may provide a display to the driver of a towing vehicle with information about the operation of the braking system and about the operation of the towed vehicle.

### CONCLUSION

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A brake monitoring system comprising:
A) a primary braking system located in a towing vehicle;
B) a towed vehicle releasably attached to the towing vehicle;
C) a towed vehicle braking system mounted in the towed vehicle;
D) an auxiliary braking device configured to activate the towed vehicle braking system and to sense at least one parameter of the auxiliary braking device or of the towed vehicle braking system;
E) a transmitter in communication with the auxiliary braking device, the transmitter configured to send a message about the parameter;
F) a receiver located in the towing vehicle, the receiver configured to receive the message from the transmitter; and
G) a display located in the towing vehicle and in communication with the receiver, the display configured to display the message to a towing vehicle occupant.

2. The system of claim 1, wherein the display comprises an alphanumeric display.

3. The system of claim 1, wherein the display is chosen from the group consisting of:
a) liquid crystal display;
b) electro-luminescent display;
c) plasma display; and
d) cathode ray tube.

4. The system of claim 1, wherein the receiver and display are mounted in a housing.

5. The system of claim 1, wherein at least one light is mounted with the display and is in communication with the receiver, the light being adapted to provide a secondary indication of the message.

6. The system of claim 1, further comprising a dimming actuator in communication with the display, the dimming actuator being adapted to control an illumination level of the display.

7. The system of claim 5, wherein the lamp is illuminated with a first color to indicate proper operation of the system and is illuminated with a second color to indicate improper operation of the system.

8. The system of claim 1 wherein at least one detector is mounted in the towed vehicle and is in communication with the transmitter, the detector being adapted to sense the towed vehicle braking system parameter.

9. The system of claim 1 further comprising performing a self test of the brake monitoring system and displaying the results of the self test on the display.

10. The system of claim 1 wherein the message is chosen from the group consisting of:
a) auxiliary braking device is ready to test;
b) auxiliary braking device test is good;
c) braking;
d) auxiliary braking device is turning off;
e) brake away cable is not operational;
f) not operational low battery;
g) battery voltage (value);
h) low battery charge battery;
i) not operational power save mode;
j) not operational call tech department;
k) not operational brake pedal is depressed;
l) not operational no brake light switch detected;
m) braking stop ASAP brakes are on;
n) stop ASAP brakes are on brake pedal is depressed;
o) tow break away emergency stop;
p) check auxiliary braking device stop ASAP;
q) tire pressure (value); and
r) tire pressure low.

11. The system of claim 1 wherein the auxiliary braking device has a processor, the processor programmed to generate the message from the parameter.

12. A method of monitoring a braking system comprising, but not necessarily in the order shown:
A) braking a towing vehicle;
B) activating a braking system in a towed vehicle;
C) sensing a parameter of the braking system in the towed vehicle or a parameter of the towed vehicle;
D) transmitting a message about the parameter from a transmitter located in the towed vehicle;
E) receiving the message on a receiver located in the towing vehicle; and
F) displaying the message to an occupant of the towing vehicle.

13. The method of claim 12 wherein the message is an alphanumeric message.

14. The method of claim 12 wherein the message is displayed on an alphanumeric display.

15. The method of claim 12 further comprising illuminating at least one light to provide a secondary indication of the message.

16. The method of claim 12 further comprising controlling an illumination level of the display.

17. The method of claim 12 wherein the message contains information about the towed vehicle tire pressure.

18. The method of claim 12 further comprising testing the braking system.

19. A device for monitoring a supplemental braking system comprising:
A) supplemental braking means for decelerating a towed vehicle;
B) detector means for detecting at least one operating parameter of the towed vehicle or of the supplemental braking means;
C) processor means for receiving the operating parameter and generating a message related to the operating parameter;
D) transmitter means for transmitting a signal containing the message;
E) receiver means for receiving the signal from the transmitter means; and
F) display means for communicating the message to an occupant of the towing vehicle.

20. The device of claim 19, wherein the display means comprises an alphanumeric display.

21. The device of claim 19, wherein illumination means are mounted with the display means for providing a secondary indication of the message.

22. The device of claim 19, further comprising dimming means for adjusting an illumination level of the display means.

23. The device of claim 19 further comprising testing means for testing the supplemental braking system.

24. The device of claim 19 wherein the operating parameter is chosen from the group consisting of:
a) supplemental braking means ready to operate;
b) supplemental braking means defective, not operational;
c) supplemental braking means in operation;
d) emergency braking condition;
e) break away cable error condition;
f) break away condition;
g) battery voltage;
h) tire pressure.

25. The system of claim 19 wherein, if a battery voltage is low, the supplemental braking means only operates during an emergency break away condition.

26. The system of claim 19 wherein, if a battery voltage is low, the supplemental braking means enters a power saving mode.
